(19) United States
(12) Patent Application Publication
(10) Pub. No.: US 2011/0021957 A1
(43) Pub. Date: Jan. 27, 2011

(54) EXERCISE ASSISTING DEVICE

(76) Inventors: Youichi Shinomiya, Ibaraki-shi (JP); Takahisa Ozawa, Katano-shi (JP); Takao Gotou, Hirakata-shi (JP); Kazuhiro Ochi, Osaka-shi (JP); Naoto Shirasawa, Kyoto-shi (JP); Masaki Nagano, Ibaraki-shi (JP)

Correspondence Address: Cheng Law Group, PLLC, 1100 17th Street, N.W., Suite 503, Washington, DC, 20036, US

(21) Appl. No.: 12/935,708

(22) PCT Filed: Mar. 23, 2009
(86) PCT No.: PCT/JP2009/055695

§ 371 Date: Sep. 30, 2010

(30) Foreign Application Priority Data
Mar. 31, 2008 (JP) PCTJP2008056443

(51) Int. Cl. A61H 1/00

(52) U.S. Cl. 601/5

(57) ABSTRACT

An exercise assisting device comprising a left step and a right step for bearing user's feet, respectively, a step driving means configured to provide a reciprocating slide motion of reciprocating and sliding the steps forward-rearward and leftward-rightward, the step driving means configured to vary a height of a front end of each the steps relative to a height of a rear end of each the steps in synchronization with the reciprocating slide motion, the step driving means configured to provide the reciprocating slide motion to each the step such that the steps travel along paths, respectively, the paths extend in non-parallel relation with each other such that the paths are laterally spaced by a distance which is different from one end to the other end of the path which gives a reciprocating slide stroke of the steps.

### TECHNICAL FIELD

This invention relates to exercise assisting devices being configured to promote exercise to the user's legs. Particularly, this invention relates to exercise assisting device being configured to provide a passive exercise to the user's legs.

### BACKGROUND ART

An exercise assisting device is previously provided. The previously provided exercise assisting device is configured to provide an external force to the user's body to give the passive exercise to the user's body, whereby the previously provided exercise assisting device expand and contract the user's muscles. That is, there is no need for the user to actively exert the power of the muscle. Patent literature 1 and Patent literature 2 disclose devices. The device in the patent literatures 1 and 2 are used for giving the exercise to the user's legs. The device is used by the user in the standing posture. The device is configured to allow the user to simulate the walking exercise in order to prevent the osteoarthritis of the knee and also to give gait training.

The training device in the patent literature 1 comprises a pair of steps for bearing the left foot and the right foot of the user. In the training device of the patent literature 1, a linear reciprocatory motion in the front-back direction and right-left direction is provided to the left step and the right step. Consequently, the training device allows the user to perform a pseudo skating motion. In this training device, the left step and the right step have a phase difference between the left step and the right step. The phase difference is set in a range from 0 degree to 360 degrees when the left step and the right step are moved in the front-back direction. Similarly, the left step and the right step has a phase difference between the left step and the right step in a range from 0 degree to 360 degrees when the left step and the right step are moved in the right-left direction. In the initial term of a start of the training device, the phase difference between the left step and the right step is set as 180 degrees. Subsequently, the phase difference between the left step and the right step is varied such that the term where the left step and the right step move to the same front-back direction is increased. The left step and the right step are driven to move by the driving unit. Therefore, there is no need for the user, mounting the left foot and the right foot on the left step and the right step, to actively or voluntary exercise. That is, when the left step and the right step are moved, the left step and the right step provide the passive exercise to the legs.

The training device in the patent literature 1 is configured to displace the weight center of the user forward-rearward and leftward-rightward. When the training device displaces the weight center of the user, the training device allows the user to cause the neural reflex for keeping the balance of the user, whereby the training device expand and contract the muscles by the neural reflex. In order to cause the expansion and the contraction of the muscles by the neural reflex, the paths of the steps extend approximately in parallel with each other such that the weight center of the user moves forward-rearward and leftward-rightward simultaneously.

The walk simulation apparatus in the patent literatures comprises a left foot support plate, a right foot support plate, and a foot support driving unit. The foot support driving unit is configured to move the left foot support plate and the right foot support plate. Furthermore, the walk simulation apparatus further comprises a means for rotating the left foot support plate and the right foot support plate forwardly and backwardly. Consequently, the heights of the feet and inclinations of the bottoms of the feet are varied according to the rotation of the left foot support plate and the right foot support plate. Furthermore, the left foot support plate and the right foot support plate in the patent literature 2 is configured to be rotatable leftward and rightward so as to vary the directions of the feet.

[Patent literature 1] Japanese patent application publication No. 2003-290386
[Patent literature 2] Japanese patent application publication No. 10-55131

### DISCLOSURE OF THE INVENTION

### Problem to be Resolved by the Invention

The training device in the patent literature 1 is configured to provide a skating action to the user by displacing “the positions of the feet” and “the position of the weight center” of the user. That is, the training device in the patent literature 1 is produced for developing the muscles of the rectus femoris muscle and the hamstrings. In order to develop the muscles of the rectus femoris muscle and the hamstrings, there is a need to expand and contract the muscles of the lower legs such as gastrocnemius muscle and soleus muscle. For expanding and contracting the muscles of the lower legs, the training device further comprises gimbals. Each one of the steps are supported by each one of the gimbals, whereby the inclination angle of each the steps are varied freely. That is, the training device is not capable of providing the stable exercise to the user having low power of the muscles of the legs when the user uses the training device. In addition, generally, the skating action applies the large load to the knees. Therefore, even if the skating action is effective for prevention of the osteoarthritis of the knee, there is a possibility that it is difficult for the user having a knee pain to use the training device.

The walk simulation apparatus in the Patent literature 2 is intended to simulate the walking action in order that the walk simulation apparatus provide “an expansion and contraction of the muscle similar to the expansion and contraction in the walking” to the muscles of the legs. Therefore, the walk simulation apparatus is preferably used for promoting a blood circulation of the vein (venous flow). However, the walk simulation apparatus applies “the load which is similar level to the load applied when the user walks” to the knee joint. Therefore, it is difficult for the user having the knee pain to use the walk simulation apparatus.

Due to this problem, the walk simulation apparatus is required to promote the expansion and contraction of the muscles of the legs for promoting the blood circulation of the vein (venous flow), while the walk simulation apparatus causes no knee pain. Such the device is strongly desired for rehabilitation of the blood circulation of the vein (venous flow).

This invention is achieved to solve the above problem. An object in this invention is to produce an exercise assisting device of passive exercise type which is configured to expand and contract the muscles of the lower thighs with times in order to promote the venous flow and in order to reduce the load applied to the knee.

### Means of Solving the Problem

The exercise assisting device in this invention comprises a left step, a right step, and a step driving means. The left step and the right step is provided for bearing user's left foot and right foot, respectively. The step driving means is configured to provide a reciprocating slide motion of reciprocating and sliding the left step and the right step forward-rearward and leftward-rightward. The step driving means is configured to vary a height of a front end of the left step relative to a height of a rear end of the left step in synchronization with the reciprocating slide motion. The step driving is configured to vary a height of a front end of the right step relative to a height of a rear end of the right step in synchronization with the reciprocating slide motion. The step driving means is configured to provide the reciprocating slide motion to each one of the left step and the right step such that the left step and the right step travels along paths, respectively. The paths extend in non-parallel relation with each other such that the paths are laterally spaced by a distance. The distance is different from one end to the other end of said paths which gives a reciprocating slide stroke of said steps.

It is preferred that the step driving means is configured to provide the reciprocating slide motion such that a lateral distance between the front ends in the reciprocating slide motion is greater than a lateral distance between the rear ends in the reciprocating slide motion.

It is preferred that the steps are attached to slide blocks through rotation shafts such that the steps are rotatable about the rotation shafts, respectively. The slide blocks are configured to reciprocate and slide leftward-rightward and forward-rearward. A front end or a rear end of each said step is linked to a vertical motion applying mechanism. The vertical motion applying mechanism is configured to vary a vertical position of each the steps in synchronization with the reciprocating slide motion, whereby said vertical motion applying mechanism being configured to vary the height of the front end of the step relative to the rear end of the step.

In this case, it is preferred that the vertical motion applying mechanism is a link having a first end and a second end. The first end of the link is coupled to the step. The second end of the link is rotatably coupled to a fixed point, whereby the vertical motion applying mechanism being configured to vary the height of the connection point between said link and said step when said link is rotated. It is also preferred that the vertical motion applying mechanism is a cam mechanism.

It is preferred that the step driving means is configured to transmit an operation force to the slide block through the vertical motion applying mechanism. The operation force causes the slide motion of said slide block. It is also preferred that the step driving means is configured to transmit an operation force to the slide block, directly. The operation force causes the reciprocating slide motion of the slide block. The vertical motion applying mechanism is configured to vary a height of the front end of the step relative to the rear end of the step in synchronization with the reciprocating slide motion.

In addition, it is preferred that the exercise assisting device further comprises a base having an upper surface for placing the steps. The step driving means being incorporated into the base. The base is provided with a handrail which is located in side portions and also front portion of the user. The handrail is provided with an emergency stop switch for stopping said step driving means.

In addition, it is preferred that the exercise assisting device further comprises a base having an upper surface for placing the steps thereon. The steps driving means is incorporated into the base. The steps are located in a portion higher than the upper surface of the base at every time. The upper surface of the step is provided with an opening for passing a connection member which connects the step driving means and said step. The base is provided with a slide cover which is shaped to cover the opening.

Furthermore, it is preferred that the exercise assisting device further comprises an information displaying means. The information displaying means is configured to obtain an exercise information indicative of the exercise of the user who places the user's feet on the steps which is reciprocated, slid, and rotated, and who performs passive exercise. The information displaying means is configured to display the exercise information.

### Effect of the Invention

In the exercise assisting device of this invention, the paths of the reciprocating slide motions of the steps by the step driving means is non-parallel relation with each other. The distance is different from one end to the other end of said path which gives a reciprocating slide stroke of said steps. Therefore, it is possible to reduce the shearing force applied to the knee joint, compared with a case where the feet are moved to the front direction of the user. In addition, this configuration makes it possible to stimulate the nerve system which is required for keeping the balance of the user, whereby causing the expansion and contraction of the required muscles. As a result, the exercise assisting device with this configuration provides the balance training to the user. In addition, the height of the front end of the step is varied relative to the height of the rear end of the step in synchronization with the reciprocating slide motion. This motion provides the dorsiflexion exercise and plantarflexion exercise to the ankle joint. As a result, the muscles of the calves are expanded and contracted, thereby improving the venous flow. Furthermore, the dorsiflexion exercise and the plantarflexion exercise are provided simultaneously. Therefore, it is possible to cause the large expansion and the large contraction of the muscles, compared with the variation of the weight applied to the soles of the feet.

In addition, in a case where the step driving means is configured to provide the reciprocating slide motion such that a lateral distance between the front ends in the reciprocating slide motion is greater than a lateral distance between the rear ends in the reciprocating slide motion, the paths of the feet of the user traces the V-shape in the top view. Therefore, it is possible to reduce the shearing force applied to the knee joint.

In addition, each the step are attached to each the slide block through the rotation shaft such that each the step is rotatable about the rotation shaft. The front end or a rear end of each the step is linked to a vertical motion applying mechanism. The vertical motion applying mechanism is configured to vary a vertical position of each the step in synchronization with the reciprocating slide motion, whereby the vertical motion applying mechanism is configured to vary a height of the front end of the step relative to the rear end of the step. Consequently, it is possible to provide the above exercise to the step by the convenient mechanism.

It is preferred that the vertical motion applying mechanism is the link having a first end and the second end. Each the first end of the link is coupled to each the step. Each the second end of the link is each the step. Each the second end of the link is rotatably coupled to the fixed point, whereby the vertical motion applying mechanism is configured to vary the height of the connection point between the link and the step when each the link is rotated. Or, it is also preferred that the vertical motion applying mechanism is the cam mechanism. Consequently, it is possible to assure the rotation motion of the step.

It is also preferred that the step driving means is configured to transmit the operation force of causing the slide motion of the slide block to the slide block through the vertical motion applying mechanism. In addition, it is also preferred that the step driving means is configured to transmit an operation force of causing the reciprocating slide motion to the slide block to the slide block, directly. With these configurations, it is possible to reciprocate and slide the step, and also to vary the height of the front end of each the steps relative to the height of the rear end of each the steps with the convenient mechanism.

Furthermore, the exercise assisting device comprises the base having the upper surface for placing the left step and the right step. The step driving means is incorporated into the base. The base is provided with the handrail which is located in side portions and also the front portion of the user on the steps. The handrail is provided with the emergency stop switch for stopping the step driving means. With the handrail, it is possible for the user having low balance ability to safely use the exercise assisting device. Furthermore, the handrail is provided with the emergency stop switch. Therefore, it is possible to stop when the user loses the user's balance, easily.

Furthermore, the exercise assisting device comprises the base having the upper surface for placing the left step and the right step. The steps are located in a portion higher than the upper surface of the base at every time. The upper surface of the step is provided with an opening for passing a connection member which connects the step driving means and the step. The base is provided with a slide cover which is shaped to cover the opening. With this configuration, it is possible to prevent the feet from being caught between the base and the step.

In addition, the exercise assisting device further comprises the information displaying means. The information displaying means is configured to obtain the exercise information indicative of the exercise of the user who places the user's feet on the steps which is reciprocated, slide, and rotated, and who performs passive exercise. The information displaying means is configured to display the exercise information. With this configuration, the user is able to keep the incentive of continuing the exercise.

### BRIEF EXPLANATION OF THE DRAWINGS

FIG. 1 shows a perspective view of an exterior of the exercise assisting device in this embodiment.

FIG. 2 shows a perspective plane view showing the steps and the step driving means.

FIG. 3 shows an explanation view explaining the operation of the step driving means.

FIG. 4 shows a plane view of the step driving means of the another embodiment.

FIG. 5 shows a side view of the above.

FIG. 6 shows a front view of the above.

FIG. 7 shows a plane view of the above without the steps.

FIG. 8 shows an exploded perspective view of the step driving means of the another embodiment.

FIG. 9A shows a partial side view of the step driving means of another embodiment.

FIG. 9B shows a partial side view of the step driving means of another embodiment.

FIG. 9C shows a partial side view of the step driving means of another embodiment.

FIG. 9D shows a partial side view of the step driving means of another embodiment.

FIG. 10 shows a side view of the step driving means of another embodiment.

FIG. 11 shows a perspective plane view of the above.

FIG. 12 shows a partial side cross sectional view of the base.

FIG. 13 shows a partial side cross sectional view of the base of another embodiment.

FIG. 14 shows a partial side cross sectional view of the base of another embodiment.

FIG. 15 A shows a front view of the presentation of the display of the operation panel.

FIG. 15 B shows a front view of the presentation of the display of the operation panel.

FIG. 15 C shows a front view of the presentation of the display of the operation panel.

FIG. 16 shows a block diagram of the above.

### EXPLANATION OF THE REFERENCE NUMERALS

1 base
2 step
3 handrail
4 operation panel
5 step driving means

### BEST MODE FOR CARRYING OUT THE INVENTION

Hereinafter, the invention is explained by the embodiment which is indicated by the attached drawings. The exercise assisting device in the figures comprises a left step 2, a right step 2, a base 1, handrails 3 (a left handrail 3 and a right handrail 3), an operation panel 4, and a step driving means 5. The left step 2 and the right step 2 are disposed on an upper surface of the base 1. The handrails 3 extend upward from the base 1. The operation panel 4 is held by the handrails 3 such that the operation panel 4 is located at a portion in the front side of the base 1. The step driving means 5 is incorporated into the base 1. The step driving means 5 is configured to operate the steps 2. When the user uses the exercise assisting device, first, the user places the left foot and the right foot on the steps 2, 2 to stand on the steps 2, 2, and holds the left handrail 3 and the right handrail 3. Subsequently, the user starts the step driving means 5. In this manner, the exercise assisting device provides the passive exercise to the user's legs by the exercise assisting device.

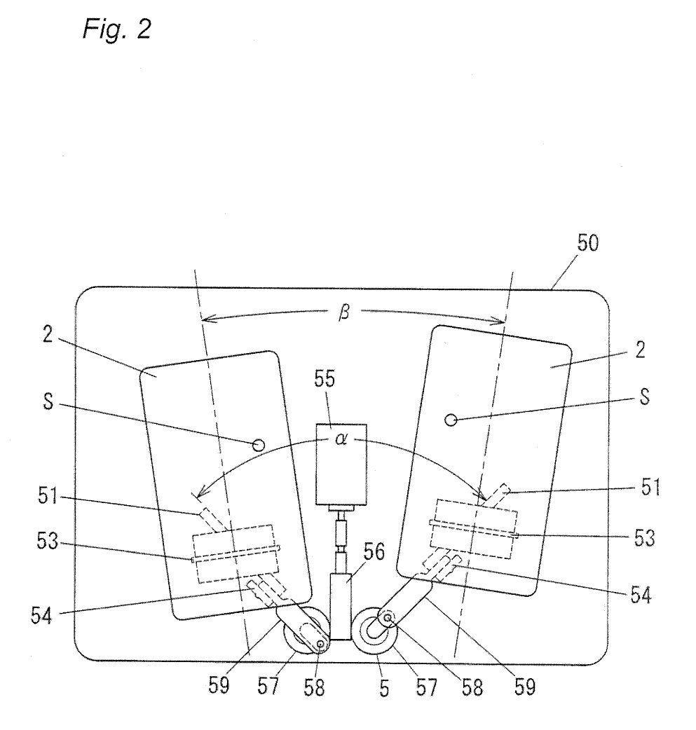

Each one of the steps 2, 2 has dimension for bearing the entire bottom of each one of the foot of the user. The steps are provided with upper surfaces which are made of material having high friction coefficient. Or, the steps are provided with the upper surfaces which are shaped so as to have the high friction coefficient. When the step driving means 5 reciprocates and slides the steps in the front-back direction and also in the left-right direction, the height of the front ends of the steps 2 is varied relative to the rear ends of the steps 2. Consequently, the step driving means repeatedly provides the plantar flexion exercise of lowering the toes of the user's feet on the steps 2, and also provides the dorsi flexion exercise of raising the toes of the user's feet on the steps 2. Each one of FIG. 2 and Fig, 3 shows a step driving means 5 being configured to move the steps as above.

The step driving means 5 shown in these figures is configured to provide the reciprocating slide motion of reciprocating and sliding the steps 2 in the front-back direction and in the left-right direction to the steps 2, and also varying the height of the front ends of the steps 2 relative to the rear ends of the steps 2 in synchronization with the reciprocating slide motion. The base plate 50 (or the bottom plate of the base 1) is provided at its left side of the upper surface with a guide rail 51, and is provided at its right side of the upper surface with a guide rail 51. Each one of the guide rail 51 holds each a slide block 52. Each the slide blocks 52 comprises a slider member which is slidably held by each the guide rail 51. Each the slide block 52 is provided at its upper side with a rotation shaft 53. The rotation shaft 53 is configured to hold the steps 2, having plate shapes, such that the steps 2 are rotatable about the rotation shafts 53, respectively. One end (rear end) of each the step 2 and the base plate 50 are linked by the link 54. A first end of each the link and the base plate 50 is connected by a universal joint 60 which defines the coupling portion. A second end of each the link 54 and each the step 2 is also connected by the universal joint 60 which defines the coupling portion.

The base plate 50 mounts a drive motor 55. The drive motor 55 is located between the slide block 52 of the left side and the slide block 52 of the right side. The drive motor 55 is provided with an output shaft. The output shaft is formed with a worm 56. The base plate 50 further mounts a pair of worm wheels 57. One of the worm wheel 57 is located in the left side of the worm 56, and the other of the worm wheel 57 is located in the right side of the worm 56. Both the worm wheels 57, 57 mesh with the worm 56. Each the worm wheel 57 is provided with an eccentric shaft 58. The eccentric shaft 58 and the link 54 are connected by the connecting rod 59. The worm wheel 57 which has the eccentric shaft 58 is spaced from the link 54 in the longitudinal direction of the guide rail 51. The worm wheel 57 and the link 54 is linked by the connecting rod 59. The first end of the connecting rod 59 and the eccentric shaft 58 are also coupled by the universal joint 60 which defines the coupling portion. The second end of the connecting rod 59 and the link 54 is also coupled by the universal joint 60 which defines the coupling portion.

When the motor 55 rotates the eccentric shafts 58 through the worm 56 and worm wheels 57, the connecting rods 59, being cooperative with the eccentric shafts 58 to construct the crank mechanism, provides a swing motion of swinging the links 54 about the universal joint 60 attached to the base plate 50. The swing motion has motion components in directions corresponding to the longitudinal directions of the guide rails 51, 51, respectively. Each the motion components provides the reciprocatory slide motion of reciprocating and sliding each the slide blocks 52 and each the step 2 to a direction which is along the guide rail 51.

Illustrations show that the guide rail 51 of the left side is not parallel with the guide rail 51 of the right side. The guide rails 51, 51 are mounted on the base plate 50 such that the distance between the front ends of the guide rails 51, 51 is larger than the distance between the rear ends of the guide rails 51, 51. Consequently, the guide rails 51, 51 are arranged to form a V-shape. Each the slide block 52 and each the step 2 are attached to each the guide rail 51. Therefore, as each the slide block 52 and each the step 2 are moved forward, each the slide block 52 and each the step 2 are moved laterally outward.

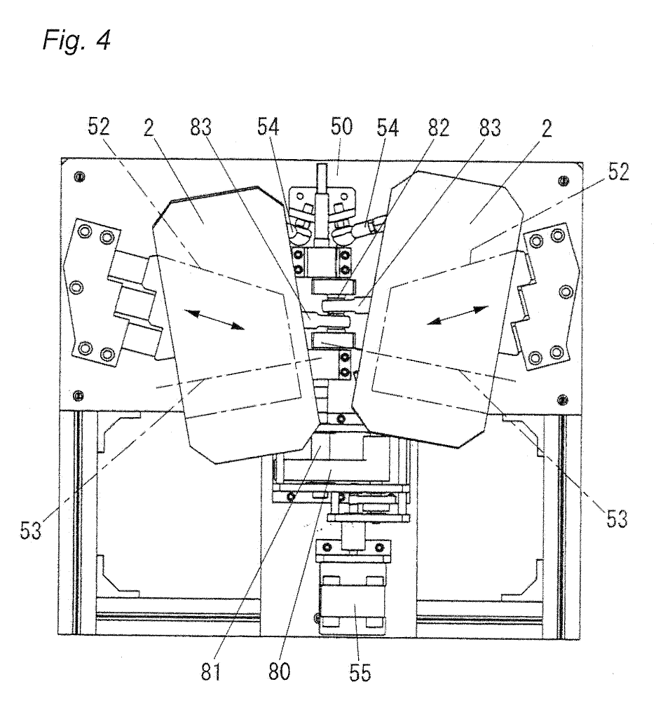

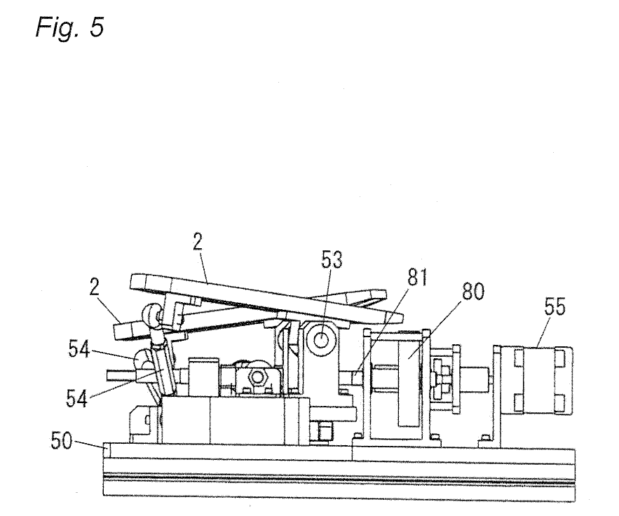

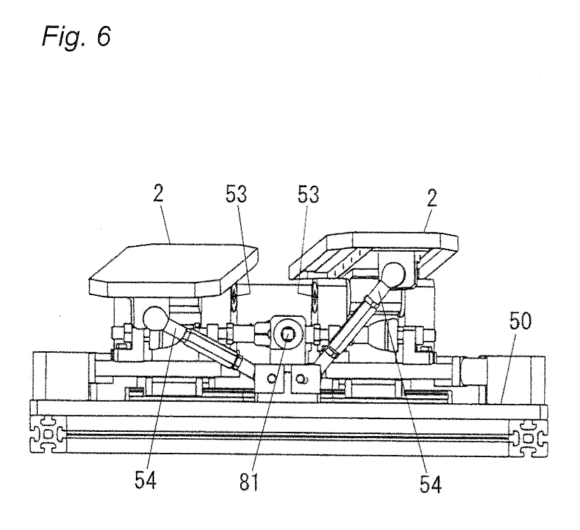

One of the guide rail 51 is inclined at α degree with the other of the guide rail 51, whereby the guide rails 51 are arranged to form the V-shape. The angle α is equal to approximately 90 degrees. However, if it is possible to reduce the shearing force which is applied to the user's knee and to cause the effective contraction and expansion of the muscles of the legs, the angle between the guide rails is not limited thereto. That is, there is a case where the angle is determined as 150 degrees shown in FIG. 4 to FIG. 7. It is preferred to employ the base plates 50 which are movable with respect to the base 1. This configuration makes it possible to vary the angle α.

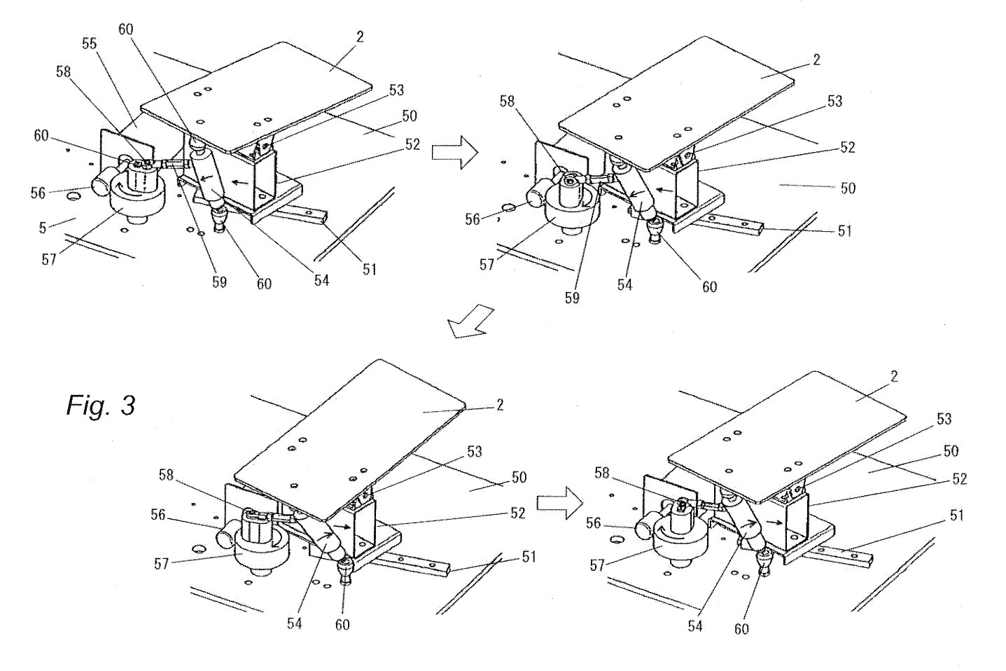

In addition, the swing motion of the link 54 allows the coupling portion between the link 54 and the step 2 to move upward and downward. The upward and downward motion of the coupling portion between the link 54 and the step 2 allows the step 2 to rotate about the rotation shaft 53. The step 2 becomes horizontal when the step 2 is located on the middle portion of the stroke of the slide motion of the step. (Upper right and the lower right of FIG. 3 show the condition where the step is located on the middle portion of the stroke of the slide motion of the step.) The rear end of the step 2 which is connected to the link 54 is raised when the step 2 is located on a first end of the stroke. (Upper left of FIG. 3 shows the condition where the step is located on the first end of the stroke.) The rear end of the step which is connected to the link 54 is lowered when the step 2 is located on a second end, which is located in an opposite relation to the first end, of the stroke. (Lower left of FIG. 3 shows the condition where the step is located on the second end of the stroke.).

Consequently, each the step 2 performs the slide motion of sliding along the guide rail 51. In addition, each the step 2 performs the rotation motion of lowering the front end of the step 2 in synchronization with the forward movement of the step which moves forward. Each the step 2 performs the rotation motion of raising the front end of the step 2 in synchronization with the rearward movement of the step 2 which moves rearward. That is to say, in this embodiment, the link 54 of the step driving means 5 is configured to transmit the operation force which causes the reciprocating slide motion of the step 2 and which causes the rotation motion of the step 2.

In addition, as is obvious from FIG. 2, the rotation shaft 53 which is defined as a rotation center of the step 2 extends along the direction perpendicular to the longitudinal direction of the step 2. In addition, the rotation shaft 53 which is defined as the rotation center of the step 2 is located on a rear side from the longitudinal center of the step 2. Furthermore, an axial direction of the rotation shaft 53 is not perpendicular to the longitudinal direction of the guide rail 51, whereby the front end (toe side) of the step 2 is located in an inside portion from the guide rail 51.

The steps 2, 2 are arranged such that the distance between the front ends of the steps 2 is greater than the distance between the rear ends of the steps 2. The steps 2, 2 are arranged to make angle of β. The angle β is equal to 10 to 30 degrees. Therefore, the user is able to place the user's feet on the steps 2, 2 while the user keeps the user's muscles in a relaxed state.

In addition, the eccentric shaft 58 of the one of the worm wheel 57, which meshes with the worm 56, is displaced from the eccentric shaft 58 of the other of the worm wheel 57 which meshes with the worm 56. The left step 2 and the right step 2 is driven to move by the step driving means such that when the right step 2 moves forward, the left step 2 moves rearward. The left step 2 and the right step 2 is driven to move by the step driving means such that when the right step 2 moves rearward, the left step 2 moves forward. That is, the left step 2 is moved in a phase which is opposite of the phase of the right step 2. The motions of the left step 2 and the right step 2 are realized by the power which is divided by the two worm wheels 57, 57, which meshes with the worm 56. Therefore, the motion of the right step 2 is in synchronization with the motion of the left step 2.

It is possible to connect the connecting rod 59 to the slide block 52, instead of the link 54. In this case, when “the slide block 52 and step 2” slides, the link 54, connecting the base plate 50 to the step 2, is rotated about one end of the base plate 50. Consequently, the height of the connecting portion, created between the link 54 and the step 2, is varied. Therefore, the step 2 is rotated about the rotation shaft 53.

FIG. 4 to FIG. 7 shows another embodiment of the step driving means 5. In the step driving means shown of FIG. 4 to FIG. 7, the left slide block 52 and the right slide block 52 are configured to slide along the left guide rail 51 and the right guide rail 51, similar to the above embodiment. Consequently, the left slide block 52 and the right slide block 52 are slidable along the front-rear direction and the left-right direction, similar to the above embodiment. In addition, each the step 2 is attached to each the slide block 52 through the rotation shaft 53, similar to the above embodiment. However, in this embodiment, the output shaft 81 is disposed between the left slide block 52 and the right slide block 52. The output shaft 81 is connected to the motor 55 through the deceleration unit 80. The output shaft 81 is provided with a crank shaft 82. The crank shaft 82 is connected to the left slide block 52 through the crank shaft 82, and is also connected to the right slide block 52 through the crank shaft 82. Consequently, when the crank shaft 82 generates the rotation force, the rotation force slides the left slide block in the direction of an arrow of FIG. 4 along the guide rail 51. Similarly, when the crank shaft 82 generates the rotation force, the rotation force slides the right slide block in the direction of an arrow of FIG. 4 along the guide rail 51.

In addition, each the step 2 on each the slide block 52 has a front side portion. Each the front side portion is connected to the base 50 through the link 54. When the slide block 52 slides, the step 2 also slides. As the slide block 52 and also the step 2 slides, the step is rotated about the rotation shaft to be rotated upward and downward. It should be noted that both ends of the rod 83 and also both ends of the link 54 is connected to the any one of the base 50, the slide block 52, and the step 2 through the universal joint.

In the embodiment shown in Figure, driving force is transmitted through the rods 52, 52. However, it is possible to connect the left slide block 52 to the right slide block 52 through a single rod. In this case, both “the eccentric shaft 58 shown in the Figure” and “the connecting rod 59” is connected to at least one of the links 54. Consequently, the slide motion and the rotation motion of the step 2 are performed.

FIG. 8 shows another embodiment. In this embodiment, the slide block 52 has four corners. The four corners are connected to the base 50 through the links 85. That is to say, the links 85 acts as a parallel link. Therefore, the slide block 52 is configured to slide along the direction of arrow in FIG. 8 such that the step 2 is slightly moved in the vertical direction. The feature of that the step 2 is supported by the rotation shaft 53 on the slide block 52 is same as the above embodiment. In addition, the feature of that the front side portion of the step 2 is connected to the base 50 through the link 54 and the universal joint is same as the above embodiment. It should be noted that FIG. 8 shows one of the slide block 52 and the step 2, and the other of the slide block 52 and the step 2 are symmetrically shaped with respect to the one of the slide block 52.

Also in this embodiment shown in FIG. 8, a first end of the connecting rod 59 is connected to the eccentric shaft 58 which is rotated. A second end of the connecting rod 59 is connected to any one of the links 85, the slide block 52, and the link 54. Consequently, the reciprocating slide motion of reciprocating and sliding the slide block 52 and the step 2, and the rotation motion of rotating the step 2 are performed.

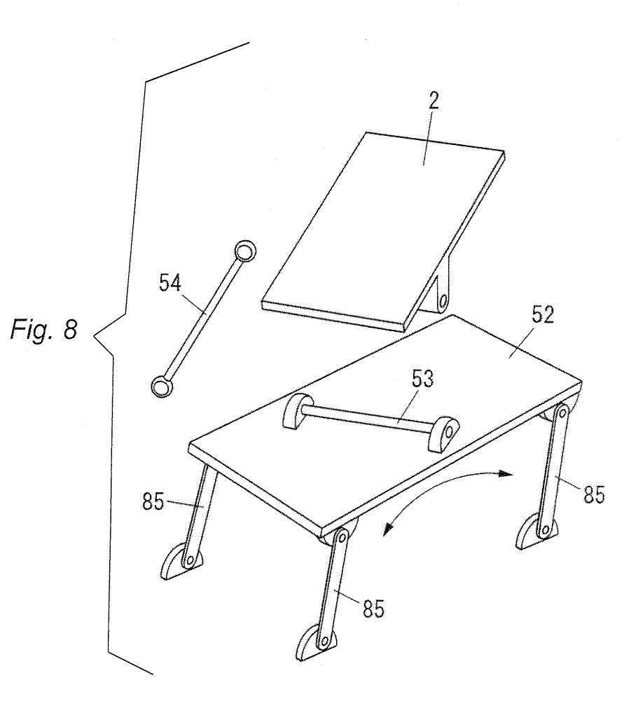

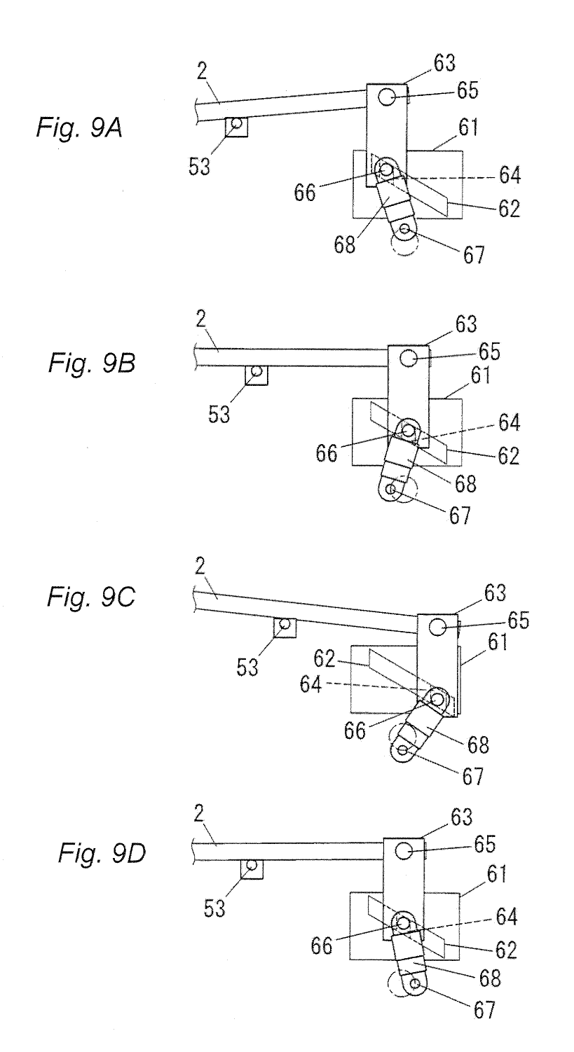

FIG. 9 shows a step driving means 5 of another embodiment. The step driving means in this embodiment comprises a cam plate 61 and a connection plate 63, instead of the link 54 shown in FIG. 2 and FIG. 3. The cam plate 61 is fixed to the base plate 50. The cam plate 61 is shaped to have a grooved cam 62 which extends downwardly from the upper side and forwardly from the rear side.

The connection plate 63 is provided with a cam follower 64. The cam follower 64 is shaped to have a rectangular shape. The cam follower 64 is configured to slide along the cam 62 which is an oblique groove. The connection plate 63 is provided with a shaft 65 which is pivotally connected to a rear end of the step 2. The slide block 52 is disposed to be slidable. The step 2 is attached to the slide block 52 through the rotation shaft to be rotatable about the rotation shaft 53. The connecting plate 63 is connected to a second end of the arm 68 through the shaft 66. The first end of the arm 68 is connected to the eccentric shaft 67. The first end of the arm 68 is rotated.

In this embodiment, when the eccentric shaft 67 which is located at a lower side of the connection plate 63 is rotated, the arm 68 moves the connection plate 63 along the cam 62. When the arm 68 moves the connection plate 63 along the cam 62, the connection arm 63 moves upward-downward and forward-rearward as well as keeps the condition shown in the figure.

Consequently, “the rear end which is defined as the connection point between the step 2 and the connection arm 63 which is connected to the step 2” is moved upward-downward as the step 2 is moved forward-rearward. As the step moves forward, the rear end of the step 2 is raised. Consequently, the front end of the step 2 is lowered. As the step moves rearward, the rear end of the step 2 is lowered. Therefore, the front end of the step 2 is raised. Obviously, it is possible to slide the step 2 along the sliding direction which is not perpendicular to the axial direction of the rotation shaft 53.

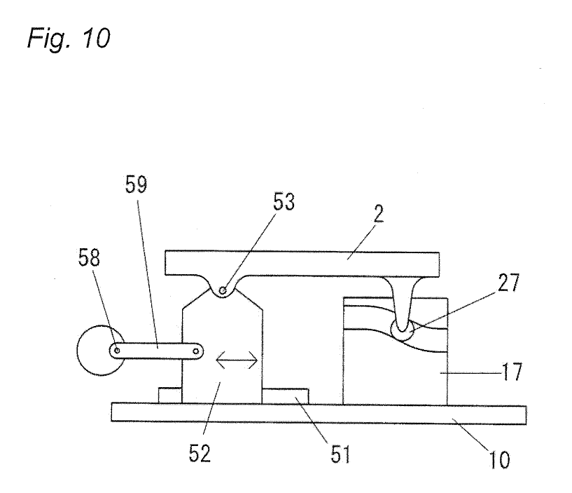

FIG. 10 shows a step driving means 5 of another embodiment. In this embodiment, the slide block 52 is reciprocated by the crank mechanism. The crank mechanism comprises an eccentric shaft 58 and a connecting rod 59. The step 2 is rotatably supported to the slide block 52 through the rotation shaft 53. The step 2 is provided at its lower surface of the front side with a cam follower 27 of roller type. The base plate 10 is formed at its upper surface with a guide cam 17 which guides the cam follower 27.

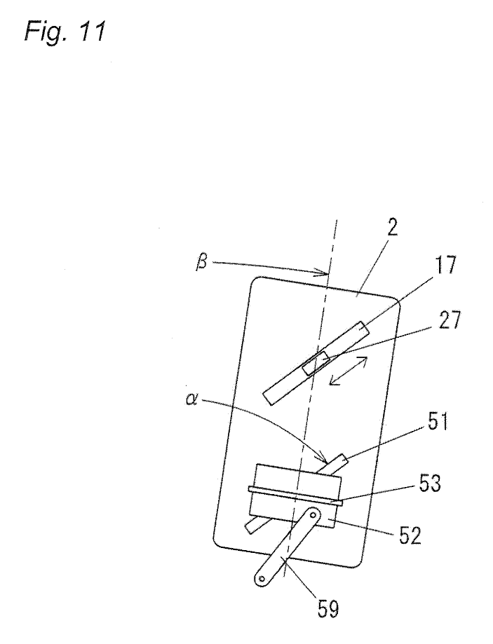

The guide cam 17 is configured to guide the cam follower 27 when the step slides. The guide cam 17 is shaped to have a grooved cam which has a curved surface. The curved surface is provided for moving the front end of the step upward-downward as the step 2 slides. When the step 2 moves forward, the front end of the step 2 is moved downward. Consequently, the front end of the step 2 is located at a position lower than the rear end of the step 2. When the step 2 moves rearward, the front end of the step 2 is moved upward. As a result, the front end of the step 2 is located at a position higher than the rear end of the step 2. Consequently, the step 2 provides the dorsiflexion and plantarflexion to the feet on the steps 2. In addition, also in this embodiment similar to the first embodiment, as shown in FIG. 11, it is possible to vary an angle β which is made by the steps 2 is different from an angle α which is made by the sliding motion of the steps 2.

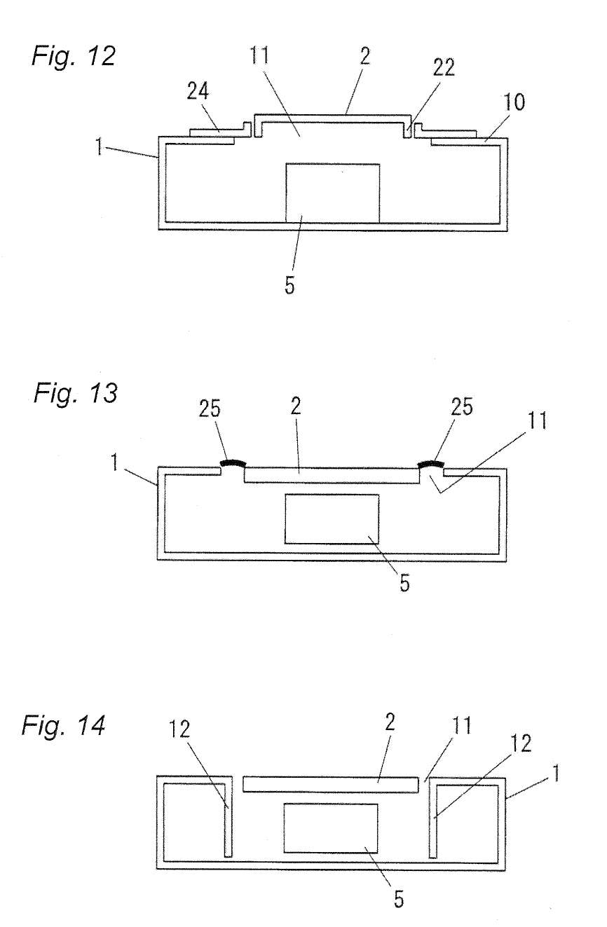

The base 1 incorporates the step driving means 5 therein. The base is provided with a top plate 10. The top plate 10 is formed with an opening 11. The steps 2 are located at an upper side of the top plate 10. The steps 2 are connected to the step driving means 5 in the base 1 at an opening 11. Furthermore, when the step 2 is driven to move by the step driving means 5 shown in FIG. 12, the step 2 is rotated. When the step 2 is rotated, the step 2 is tilted forward and rearward. However, the entire area of the step 2 is located at a position which is higher than the top plate 10 at every moment.

Consequently, even if there is a possibility that the feet on the steps 2 protrude to the outside of the steps 2, it is possible to prevent the feet from being caught between the top plate 10 and the base 1. In addition, as shown in FIG. 12, it is preferred that each the step 2 is provided at its periphery with a skirt 22. In addition, it is preferred to employ each the slide cover 24. The slide cover 24 surrounds the step 2. The side cover 24 is configured to slide relative to the top plate 10 when the step 2 moves forward-rearward and leftward-rightward. Consequently, it is possible to safely use the exercise assisting device.

As shown in FIG. 13, it is preferred that the outer circumference of the step 2 is widely spaced from the inner circumference of the opening 11. Consequently, it is possible to prevent the contact of the feet to the top plate even if the feet are displaced from the step 2. In addition, it is more preferred that to employ the cover such as bellows having stretch property such that the cover connects the space between the outer circumference of the step 2 and the inner circumference of the opening 11. Consequently, it is possible to prevent the entry of the feet to a gap between the outer circumference of the step 2 and the inner circumference of the opening 11. Especially, it is preferred to employ the cover 25 which has a color different from the color of the surface of the top plate 10 and the step 2. Similarly, it is preferred to employ the cover 25 which is made of a transparent material different from the material of the top plate 10 and the step 2. With this configuration, the user is able to clearly recognize the gap being covered by the cover 25 disposed between the outer circumference of the step 2 and the inner circumference of the opening 11. With this configuration, it is possible to prevent the displacement of the feet from the step 2, easily.

As shown in FIG. 14, it is preferred to employ a cover plate 12. In this case, the cover plate 12 covers from the inner circumference to an inside of the base 1, With this configuration, the cover plate 12 prevents the foot from being caught between the step 2 and the lower surface of the top plate 10 even if the foot is projected from the step when the feet slips.

In addition, it is possible to employ a foot holding means. The foot holding means is exemplified by a strap which is configured to hold the foot on the step 2. This configuration also makes it possible to prevent the shift of the position of the feet.

When the user uses the above mentioned exercise assisting device, first, the user places the user's left foot and the right foot on the left step 2 and the right step 2, respectively, and holds the handrail 3. Subsequently, the user turns on the operation switch on the operation panel 4. Consequently, the step driving means 5 is started. When the step driving means 5 is started, the left step 2 and the right step 2 is moved frontward-rearward and leftward-rightward such that phase of the motion of the left step 2 is opposite to the phase of the motion of the right step 2. In addition, when each the step 2 moves forward, the front end of each the step 2 moves downward. When each the step 2 moves rearward, the rear end of each the step 2 moves downward.

Consequently, when the user places the user's feet on the steps 2, the user's feet is moved frontward-rearward and leftward-rightward according to the motion of the steps 2. In addition, the rotation of the step 2 provides the dorsi flextion motion exercise and the plantar flex motion exercise to each the ankle joint. When the steps are moved forward-rearward and leftward-rightward, the phase of the motion of the left step 2 is shifted from the phase of the motion of the right step 2 by 180 degrees. Therefore, it is possible to reduce the displacement of the weight center of the user, on the steps 2, in the front-rear direction. Therefore, even if the user having low balance ability uses the exercise assisting device, there is little possibility of breaking the balance of the user according to the movement caused by the step 2. Furthermore, the weight center is moved leftward-rightward. This movement stimulates the nerve system which is required for keeping the balance of the user. Furthermore, this movement also causes the muscles required for keeping the balance of the user to contract and expand. Therefore, it is suitable to provide the balance training without fear.

In addition, the one of the steps 2 is moved forward-rearward and leftward-rightward in the phase which is opposite to the phase which is caused when the other of the steps 2 is moved forward-rearward and leftward-rightward, whereby the variation of the feet position is caused. The variation of the feet position is similar to the walking exercise. Therefore, the muscles of at least the lower legs is expanded and contracted similar to the walking exercise. In addition, when the step 2 is located in the rear end position in the forward-rearward motion, the position of foot is located at rear position than the weight center of the user. Therefore, when the step 2 is located in the rear end position in the forward-rearward motion, it is possible to tense “the muscles of the rear side of the femoral muscles” and “the muscles of the buttocks”.

In general walking exercise, each the foot is moved forward and rearward, mainly. However, it is preferred to move each the foot leftward-rightward in addition to the forward-rearward. In this case, it is possible to twist the body trunk, compared with the case where the foot is moved only forward and rearward or where the foot is moved only leftward and rightward. The twist of the body trunk provides the stimulation to inward organs. Furthermore, the twist of the body trunk breaks the balance of the user in multiple directions positively. The breaking of the balance of the user in the multiple directions provides the stimulations to the muscles of the lower legs and the femoral areas (adducent muscles, rectus femoris, medial great muscles, lateral great muscles, biceps femoris, semitandinosus muscles, semimembranosus). Although the stimulation to the muscles of the above is low load and passive exercise, an amount of the sugar which is consumed by the muscles is increased. As a result, the improvement of the type 2 diabetes is promised.

In addition, when the dorsi flex exercise is provided to each the foot, the Achilles tendon is stretched. Therefore, the movable range of the ankle is expanded. Furthermore, when the plantar flex exercise is provided to each the foot, the load is applied to the each the toes. Therefore, it is possible to lessen the hallux valgus. In addition, when the dorsi flex exercise and the plantar flex exercise are alternately provided to each the foot, expansion and contraction of the muscles of the lower legs such as gastrocnemius and soleus muscleare are caused. The expansion and the contraction of the muscles of the lower legs increase the venous flow of the legs. As a result, it is possible to relieve the swelling of the legs.

The operation of the step driving means 5 which is started by turning on the operation switch is stopped when the operation switch is operated again. Furthermore, it is possible for the step driving means 5 to stop the operation of the step driving means after a lapse of a predetermined period. Furthermore, it is also preferred for the step driving means 5 which is configured to adjust an operation period of the step driving means 5 by the user.

As is obvious from the configuration of the step driving means 5, the phase difference in the forward-rearward and leftward-rightward between left step 2 and the right step 2 is determined by the positions of the eccentric shafts of the worm wheels 57. That is, the phase difference in the forward-rearward and leftward-rightward between left step 2 and the right step 2 is determined by meshing positions where each the worm wheels 57 meshes with the worm 56.

Therefore, desirable phase difference is set by varying the meshing position. That is to say, it is possible to move the left step 2 in the phase which is equal to the phase of the right step 2, easily. When the left step 2 is moved in the phase which is equal to the phase of the right step 2, the weight center of the user is moved forward-rearward. Therefore, it is possible to provide not only the exercise of the muscles of the legs but also the muscles of the lower back which is required for keeping the balance to the user.

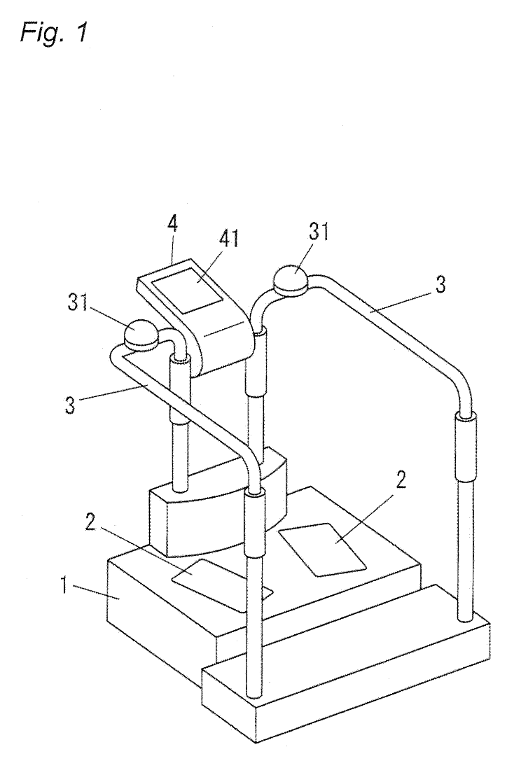

The user is able to use the exercise assisting device in order to perform the passive exercise while the user holds the handrails 3. Therefore, even if there is a possibility of breaking the balance of the user, it is possible to prevent the falling of the user from the exercise assisting device. However, in order to improve the safety when the user loses the balance, as shown in FIG. 1, the handrails 3 are provided with emergency stop buttons 31. Each one of the emergency stop buttons 31 is configured to stop the operation of the step driving means 5. The emergency stop button 31 is easily pushed by the hand holding the handrail 3 when the some sort of the accident is occurred.

It is also preferred that the step 2 is provided with a weight detection switch S. The weight detection switch 6 is realized by a pressure sensor. In this case, the step driving means 5 is configured to stop the step 2 when the weight detection switch 5 detects no weight in a condition where the step driving means 5 drives the steps 2. Consequently, it is possible to automatically stop the step driving means 5 when the foot is removed from the step 2 due to the balance loss.

It is preferred that the speed of the motor 55 is gradually varied when the operation of the step 2 is started or stopped. That is to say, there is a possibility that each the foot is not able to follow the abrupt acceleration and the abrupt cessation of the step 2. This increases the possibility of losing the balance of the user.

In addition, it is preferred to control the rotation of the motor 55 such that both the steps 2 have a horizontal condition when the step 2 is stopped. Consequently, it is possible for the user to easily ride on the steps 2. It is also preferred to employ the weight detection switches. In this case, even if the operation switch is operated, the step driving means 5 is configured to be deactivated when both the weight detection switches are not turned on.

By the way, it is difficult for unmotivated user to continuously use the exercise assisting device of the above passive type. In response to this problem, it is preferred that the exercise assisting device in this invention has a measuring function of measuring an amount of exercise and also a setting function of setting an amount of target exercise. Furthermore, it is preferred that the exercise assisting device is configured to display the comparative result which is resulted from the comparison of an amount of the target exercise with a total amount of the exercise at present.

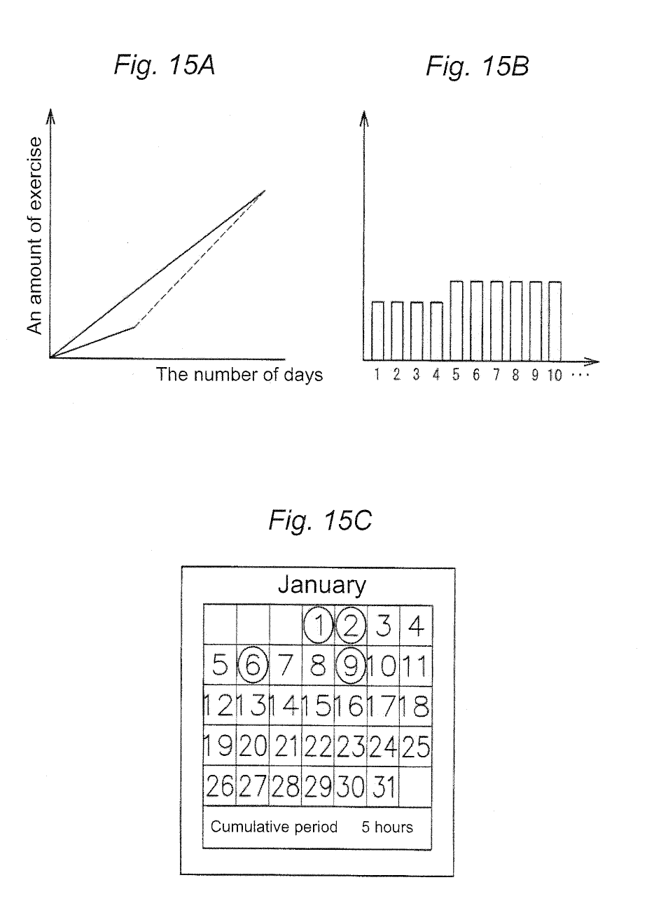

For example, as shown in FIG. 15A, if an amount of the target exercise in one month is set, the display 41 of the operation panel 4 displays a line graph showing a relationship between the target value and a cumulative value of an amount of exercise measured per one day. Furthermore, for example, as shown in FIG. 15B, the display 41 of the operation panel 4 displays a graph showing an amount of the daily exercise which is required for achieving an amount of the target exercise. In addition, as shown in FIG. 15C, it is also preferred that the display 41 of the operation panel 4 having an exercise history display function of displaying a calendar which shows the day when the user exercises. Furthermore, it is also preferred that the display 41 of the operation panel 4 is configured to display requital when the cumulative value of an amount of exercise reaches an amount of the target exercise.

It is preferred that display 41 of the operation panel 4 is configured to display the walking distance which is calculated on the basis of an amount of the exercise. In this case, the display 41 shows a map indicating a course where the user should accomplished. In addition, the display 41 is configured to show the walking distance from the start point to the goal point on the course of the map. With this configuration, the user is able to enjoy the accomplishment of an amount of the target exercise. In addition, it is preferred to prepare a plurality of course. With this configuration, the user is able to enjoy what course the user runs. Needless to say, it is preferred that the display 41 is configured to display the live action of the course, and also computer graphic of the course. With this configuration, the exercise is more enjoyed.

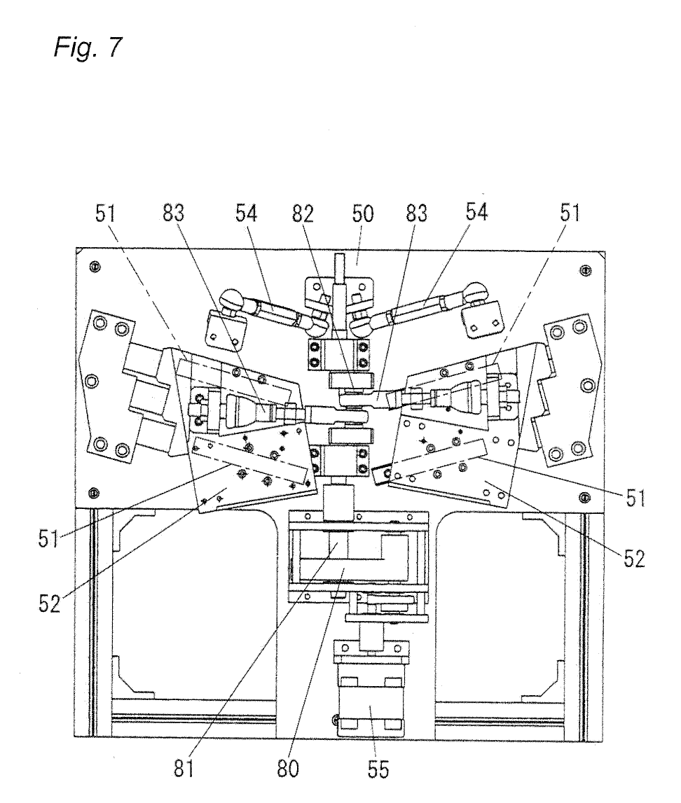

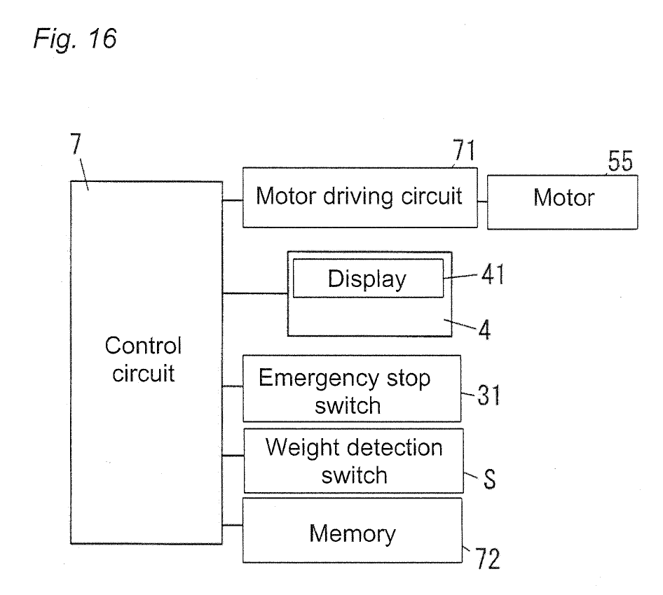

FIG. 16 shows a block diagram of the exercise assisting device which comprises the measurement function of measuring an amount of the exercise and the exercise history display function. FIG. 7 shows a control circuit 7 being configured to control the motor driving circuit 71 for the motor 55 of the step driving means 5. The control circuit 7 is realized by one chip microcomputer. The control circuit 7 is connected to the switches and the display 41 of the operation panel 4. The control circuit 7 further connected to the memory unit 72 which is configured to store the exercise history information, an target amount of the exercise, and a map information. The control circuit 7 is configured to calculate an amount of the exercise on the basis of the operation period of the operation period, the speed of the motor, and the user's weight which is entered by the operation panel 4 (or which is detected by the weight detection switch S). The control circuit 7 is configured to store an amount of the calculated exercise which is associated to the date on the memory 72. The control circuit 7 is configured to read an amount of the exercise in one month from the memory unit 72, and to calculate a cumulative value of an amount of the exercise by summing up an amount of the exercise in one month. The control circuit 7 is configured to compare a cumulative value of an amount of the exercise with a target amount of the exercise. The control circuit 7 is configured to display the above comparative result, and to display the walking distance corresponding to the cumulative value on the map. Needless to say, the control circuit 7 is configured to store the information of the above by each the users.

In order to display an amount of the exercise of the user and the exercise history of the user to the user, it is possible to employ the sound and also the light of the LED for informing the above information, instead of the display 41. Furthermore, it is preferred to employ the biological information detection means which is configured to detect the biological information such as cardiac beat of the user, and is configured to display the biological information to the user.

1. An exercise assisting device comprising:
a left step and a right step for bearing user's left foot and right foot, respectively;
a step driving means being configured to provide a reciprocating slide motion of reciprocating and sliding said left step and said right step forward-rearward and also leftward-rightward,
said step driving means being configured to vary a height of a front end of said left step relative to a height of a rear end of said left step in synchronization with the reciprocating slide motion,
said step driving means being configured to vary a height of a front end of said right step relative to a height of a rear end of said right step in synchronization with the reciprocating slide motion,
said step driving means being configured to provide the reciprocating slide motion to each one of said left step and said right step such that said left step and said right step travels along paths, respectively,
said paths extends in non-parallel relation with each other such that said paths are laterally spaced by a distance,
the distance is different from one end to the other end of said path which gives a reciprocating slide stroke of said steps.

2. The exercise assisting device as set forth in claim 1, wherein
said step driving means being configured to provide the reciprocating slide motion such that a lateral distance between the front ends in the reciprocating slide motion is greater than a lateral distance between the rear ends in the reciprocating slide motion.

3. The exercise assisting device as set forth in claim 1, wherein
said steps are attached to slide blocks through rotation shafts such that said steps are rotatable about said rotation shafts, respectively,
said slide blocks are supported to be slidable and reciprocatable leftward-rightward and forward-rearward,
a front end or a rear end of each said step is linked to a vertical motion applying mechanism,
said vertical motion applying mechanism being configured to vary a vertical position of each the steps in synchronization with the reciprocating slide motion, whereby said vertical motion applying mechanism being configured to vary a height of the front end of the step relative to the rear end of the step.

4. The exercise assisting device as set forth in claim 3, wherein
said vertical motion applying mechanism is a link having a first end and a second end,
said first end of said link is coupled to said step,
said second end of said link is rotatably coupled to a fixed point, whereby said vertical motion applying mechanism being configured to vary the height of a connection point between said link and said step when said link is rotated.

5. The exercise assisting device as set forth in claim 4, wherein
said vertical motion applying mechanism is a cam mechanism.

6. The exercise assisting device as set forth in claim 3, wherein
said step driving means being configured to transmit an operation force to said slide block through said vertical motion applying mechanism,
the operation force causes the slide motion of said slide block.

7. The exercise assisting device as set forth in claim 3, wherein
said step driving means is configured to transmit an operation force to said slide block, directly,
the operation force causing the reciprocating slide motion to the slide block,
said vertical motion applying mechanism being configured to vary a height of said front end of said step relative to said rear end of said step in synchronization with the reciprocating slide motion.

8. The exercise assisting device as set forth in claim 1, wherein
said exercise assisting device further comprises a base having an upper surface,
said steps being disposed on said upper surface,
said step driving means being incorporated into said base,
said base is provided with a handrail which is located in side portions and also a front portion of the user,
said handrail being provided with an emergency stop switch for stopping said step driving means.

9. The exercise assisting device as set forth in claim 1, wherein
said exercise assisting device further comprises a base having an upper surface,
said steps being disposed on said upper surface,
said step driving means being incorporated into said base,
said steps are located in a portion higher than said upper surface of said base at every time,
said upper surface of said step is provided with an opening for passing a connection member which connects said step driving means and said step,
said base is provided with a slide cover which is shaped to cover said opening.

10. The exercise assisting device as set forth in claim 1, wherein
said exercise assisting device further comprises an information displaying means,
said information displaying means being configured to obtain an exercise information indicative of exercise of the user who places the user's feet on said steps which is reciprocated, slid, and rotated, and who performs passive exercise,
said information displaying means being configured to display the exercise information.

11. The exercise assisting device as set forth in claim 2, wherein
said steps are attached to slide blocks through rotation shafts such that said steps are rotatable about said rotation shafts, respectively,
said slide blocks are supported to be slidable and reciprocatable leftward-rightward and forward-rearward,
a front end or a rear end of each said step is linked to a vertical motion applying mechanism,
said vertical motion applying mechanism being configured to vary a vertical position of each the steps in synchronization with the reciprocating slide motion, whereby said vertical motion applying mechanism being configured to vary a height of the front end of the step relative to the rear end of the step.

12. The exercise assisting device as set forth in claim 11, wherein
said vertical motion applying mechanism is a link having a first end and a second end,
said first end of said link is coupled to said step,
said second end of said link is rotatably coupled to a fixed point, whereby said vertical motion applying mechanism being configured to vary the height of a connection point between said link and said step when said link is rotated.

13. The exercise assisting device as set forth in claim 12, wherein
said vertical motion applying mechanism is a cam mechanism.

14. The exercise assisting device as set forth in claim 11, wherein
said step driving means being configured to transmit an operation force to said slide block through said vertical motion applying mechanism,
the operation force causes the slide motion of said slide block.

15. The exercise assisting device as set forth in claim 11, wherein
said step driving means is configured to transmit an operation force to said slide block, directly,
the operation force causing the reciprocating slide motion to the slide block,
said vertical motion applying mechanism being configured to vary a height of said front end of said step relative to said rear end of said step in synchronization with the reciprocating slide motion.
